(19) United States
(12) Patent Application Publication
(10) Pub. No.: US 2013/0120974 A1
(43) Pub. Date: May 16, 2013

(54) Wall Wash Lighting Fixture

(71) Applicant: Electrix, Inc., New Haven, CT (US)

(72) Inventors: Gordon L. Swisha, Fairfield, CT (US); Joseph J. LoMenzo, Shelton, CT (US); David M. Aikens, Chester, CT (US)

(73) Assignee: ELECTRIX, INC., New Haven, CT (US)

(21) Appl. No.: 13/672,839

(22) Filed: Nov. 9, 2012

Related U.S. Application Data
(60) Provisional application No. 61/558,072, filed on Nov. 10, 2011.
(60) Provisional application No. 61/673,947, filed on Jul. 20, 2012.

(51) Int. Cl. F21S 4/00; F21S 8/02; B23P 11/00; F21V 5/04

(52) U.S. Cl. 362/147; 362/235; 362/335; 29/428

(57) ABSTRACT

A light fixture has a body and a plurality of light emitting diodes. A carrier supports the light emitting diodes and is pivotally mounted to the body. An asymmetric lens is mounted to the carrier.

### CROSS-REFERENCE TO RELATED APPLICATIONS

Benefit is claimed of U.S. Patent Applications Ser. Nos. 61/558,072 and 61/673,947, filed Nov. 10, 2011 and Jul. 20, 2012, and entitled “Wall Wash Lighting Fixture”, the disclosures of which are incorporated by reference herein in their entireties as if set forth at length.

### BACKGROUND OF THE INVENTION

The invention relates to architectural lighting. More particularly, the invention relates to a wall wash lighting fixture.

In architectural lighting, it is often desired to wash a wall with light. Light fixtures are located in the ceiling near the wall and positioned to direct light downward along the wall (grazing the wall). In such fixtures, much light is wasted. Additionally, there is often an uneven pattern with a harsh high illumination region near the fixture.

Linear LED wall wash lighting fixtures have been recently proposed.

### SUMMARY OF THE INVENTION

The directionality and compactness of light emitting diodes (LEDs) provides an opportunity to create an efficient wall wash/graze fixture. Pattern uniformity may be improved by providing an asymmetrical optic.

One aspect of the disclosure involves a light fixture comprising: a body; a plurality of light emitting diodes; a carrier supporting the light emitting diodes (LEDs) and pivotally mounted to the body; and an asymmetric lens mounted to the carrier.

Another aspect involves an asymmetric lens (e.g., which may be used as a replacement lens in a fixture). The lens has a first surface for receiving light and a second surface for discharging the received light. The lens asymmetry may provide means for asymmetrically shifting the received light (e.g., a light distribution from an LED array).

In various embodiments, the body is elongate in a first lateral direction and the pivotal mounting is parallel to said first lateral direction.

In various embodiments, a latch secures the pivotal mounting of the carrier. The latch may stepwise secure the pivotal mounting of the carrier.

In various embodiments, the lens is an asymmetrical extrusion or injection molding.

In various embodiments, the lens asymmetry asymmetrically collimates the output of the LEDs.

In various embodiments, the pivotal mounting is provided by at least one hinge; and

In various embodiments, the carrier comprises two alternative mounting features so as to allow mounting the carrier relative to the hinge in two alternative orientations (e.g., at 90° relative to each other, more broadly, 30-120° or 60-120° or 80-100°).

In various embodiments, the plurality of light emitting diodes are mounted to a circuit board. The lens may be secured to an extruded main body of the carrier to sandwich the circuit board between the lens and the main body. The lens may straddle the light emitting diodes with a plurality of tabs attached with screws through the tabs and the circuit board and an opposite lip captured by a channel in the carrier main body.

In various embodiments, the plurality of light emitting diodes are in a linear array to emit a pattern of light having a centerplane. The asymmetry of the lens may distribute light from one side of the centerplane differently than light from the other side of the centerplane. The asymmetry of the lens may compress the distribution light from said one side of the centerplane. The asymmetry of the lens may compress the distribution light from said other side of the centerplane. The asymmetry of the lens may redirect (reorient/rotate) light emitted along the centerplane (e.g., to one side of the centerplane).

In various embodiments, the lens may have a convex outer profile and a concave inner profile.

In various embodiments, the asymmetry of the lens may be expressed by the first surface, or the second surface, or both the first and second surfaces.

In various embodiments, the first surface, the second surface, or both may be described as a piecewise discontinuous construction of several segments, each of which can be described mathematically by a spline, NURBS or other mathematical formalism.

In various embodiments, the first surface of the lens may be a concave assymetric shape which is a scaled and shifted version of the second surface convex assymetric shape.

In various embodiments, the body and the carrier are each formed as an aluminum or an aluminum alloy extrusion.

In various embodiments, the pivotal mounting of the carrier to the body is provided by cooperation of a bead on one of the body and the carrier with a channel on the other of the body and the carrier.

In various embodiments, the fixture may be mounted to a wall and ceiling wherein: the body is supported by the wall; a peripheral portion of the ceiling is mounted to the body; and the plurality of light emitting diodes are recessed above a surface of the ceiling and positioned to direct light along the wall.

A method for installing the fixture may comprise: mounting the body to a wall; mounting a peripheral portion of a ceiling to the body; and adjusting the carrier so that the plurality of light emitting diodes are oriented and positioned to direct light along the wall.

In various embodiments, a plurality of said fixtures are assembled end-to-end.

In various embodiments, the mounting of the body is via a plurality of brackets and the mounting of the peripheral portion of the ceiling comprises screwing directly to the body.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a first view of a wall wash light fixture.

FIG. 2 is second view of the wall wash light fixture.

FIG. 3 is a side view of a wall wash light fixture.

FIG. 4 is an enlarged view of the fixture of FIG. 3.

FIG. 5 is a partial sequential side view of a partial installation/assembly sequence.

FIG. 6 is a partial sequential side view of a partial articulation/adjustment sequence.

FIG. 7 is a schematic view showing asymmetric redirection of light.

FIG. 8 is a view of a second fixture.

FIG. 9 is a second view of the second fixture.

FIG. 10 is a side view of the second fixture.

FIG. 11 is a side view of the second fixture with endcap removed driver box cutaway.

FIG. 12 is a view showing asymmetric redirection of light from the second fixture.

FIG. 12A is an enlarged view of the view of FIG. 14.

FIG. 13 is a view of a corner adaptor for use of the second fixture.

FIG. 14 is a view of the second fixture with an endplate.

FIG. 15 is a view of a spacer assembly.

FIG. 16 is a view of a drop ceiling adaptor for use in the second fixture.

FIG. 17 is a view of a third fixture.

FIG. 18 is an end view of the third fixture.

FIG. 19 is a view of the fixture of FIG. 18 with luminaire assembly endplate removed.

FIG. 19A is an enlarged view of the luminaire assembly of FIG. 19.

FIG. 20 is an exploded plan view of the sub-assembly of the printed circuit board and optic of the third fixture.

FIG. 21 is a rear view of the optic of the third fixture.

FIG. 22 is a rear view of the third fixture.

FIG. 23 is a top view of the third fixture.

FIG. 24 is a view showing articulations of the fixture of FIG. 18.

FIG. 25 is a side view of the fixture of FIG. 18 shown in a cove lighting situation for lighting ceiling.

FIG. 26 is an end view of the third fixture (with endplate removed) and showing a different mounting of the luminaire assembly to the driver box.

FIG. 27 is a side view of the fixture of FIG. 26 mounted to a ceiling to provide a wall wash or mounted to a wall to provide a ceiling wash.

Like reference numbers and designations in the various drawings indicate like elements.

### DETAILED DESCRIPTION

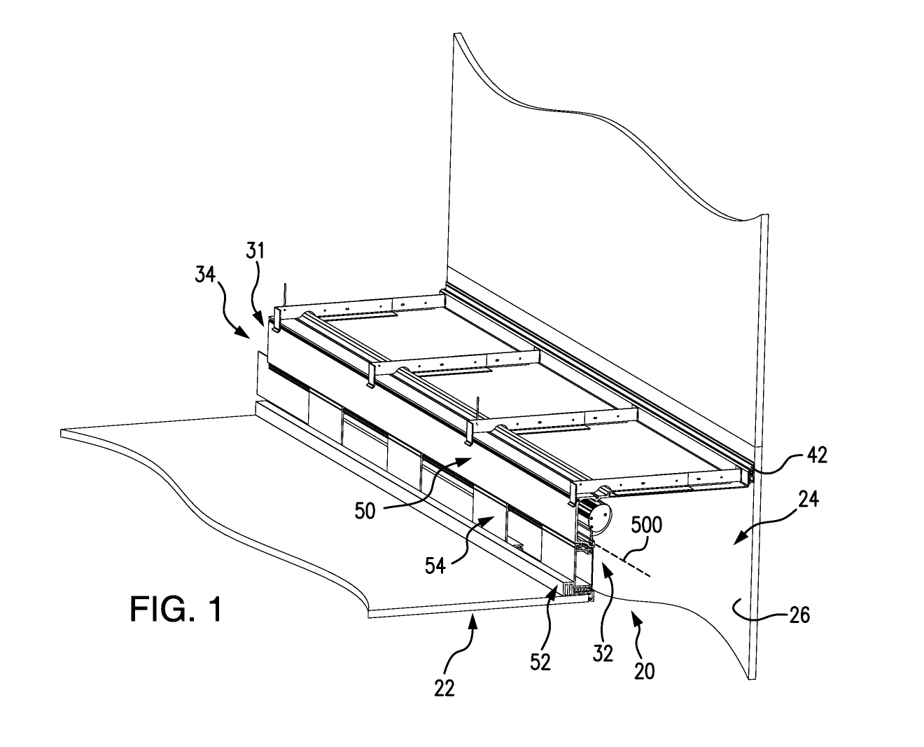

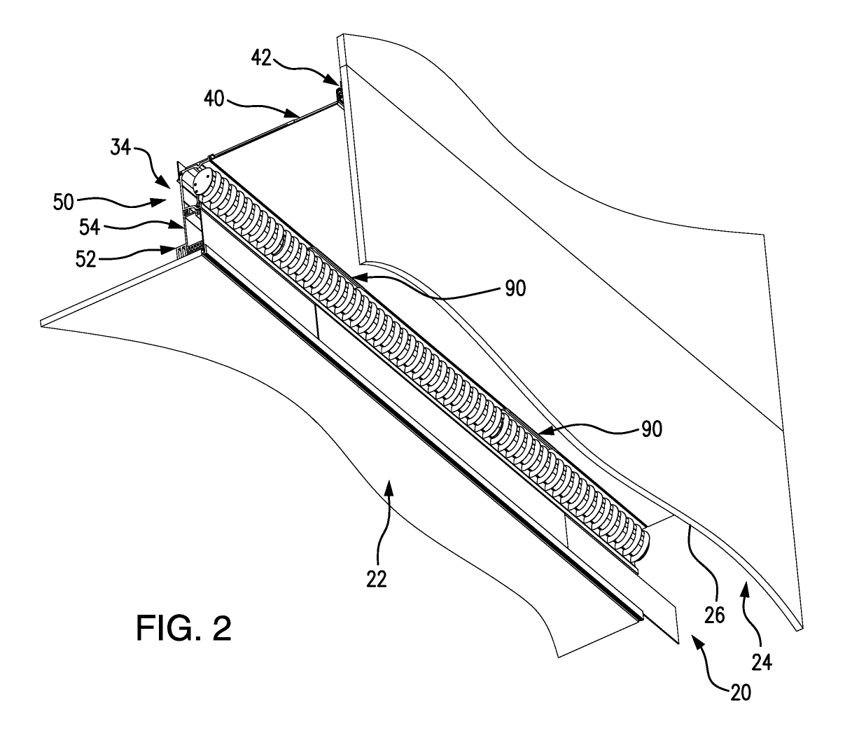

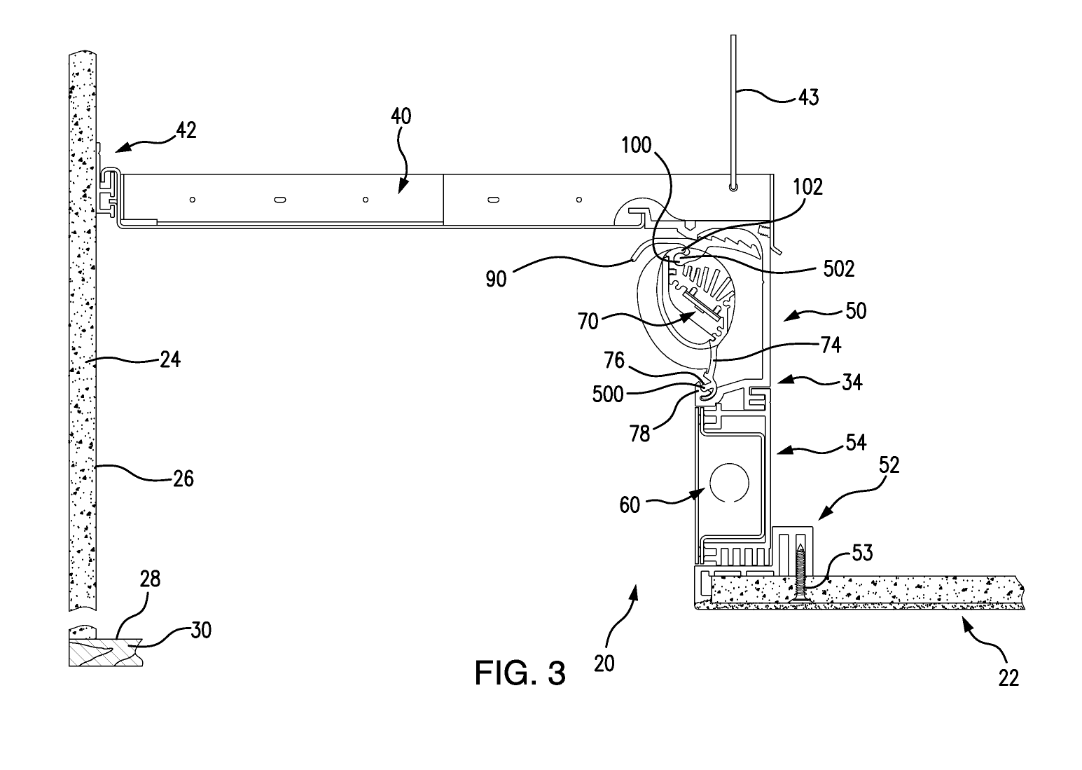

FIGS. 1-3 show a fixture 20 recessed in a ceiling 22 along the junction of that ceiling with a wall 24. The wall 24 has a surface 26 extending downward to a surface 28 (FIG. 3) of a floor structure 30. The fixture extends from a first end 31 to a second end 32.

The fixture is secured via mounting brackets 40 (e.g., stamped cold rolled steel (CRS)) to the wall. The exemplary brackets 40 are, themselves, secured to the wall via an elongate wall bracket 42 (e.g., extruded aluminum alloy) secured to the wall (e.g., screwed). In the exemplary implementation, a downward facing hook at the wall end of the bracket 40 mates with an upward facing hook of the bracket extrusion 42 to support the bracket 40 near the wall. At the opposite end of the bracket 40, the bracket 40 may be suspended by a guy wire 43 from a structural ceiling, beam, or the like.

A fixture body 34 is mounted to the brackets. The exemplary fixture body may, in turn, locally support or be otherwise secured to the ceiling (e.g., a gypsum board or the like). Exemplary body length is in excess of 20 cm (e.g., 50 cm-5 m, more narrowly, 50 cm-3 m). The exemplary body 34 comprises a multi-piece assembly (e.g., multiple pieces at a given position along the wall). The exemplary multi-piece assembly comprises a continuous luminaire channel (main body) 50 (e.g., extruded aluminum) holding the light source as discussed below. A continuous cleat 52 (e.g., also an aluminum extrusion) is below the luminaire channel and is extruded with channels which receive screws 53 (FIG. 3) for mounting a perimeter portion of the ceiling boards. Spaced-apart staggered brackets 54 (e.g., aluminum extrusion) connect the cleat 52 to the channel 50 to support the cleat from the channel. The brackets 54 may contain a driver box 60 (FIG. 3) for containing electronic drivers.

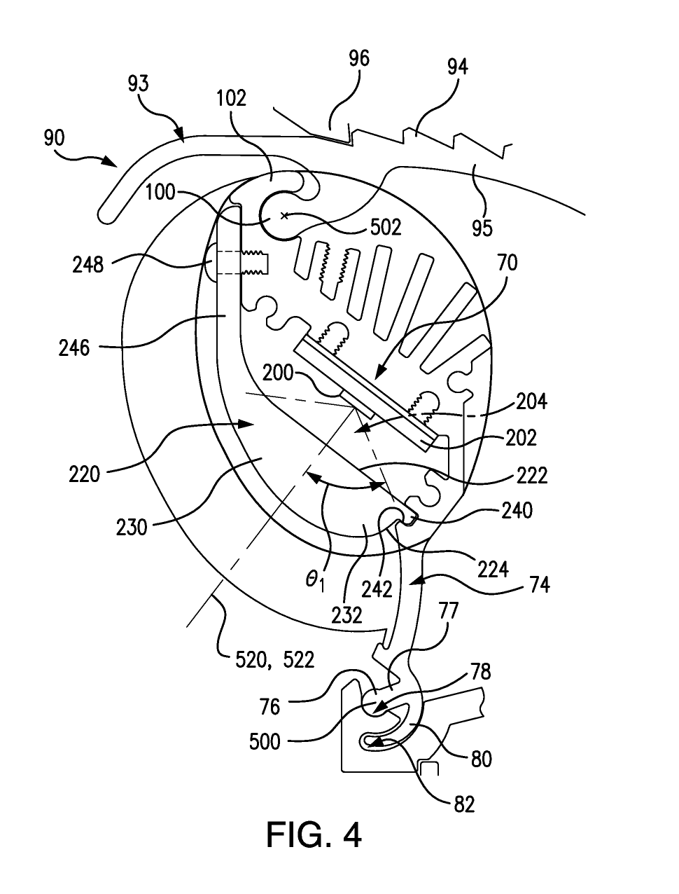

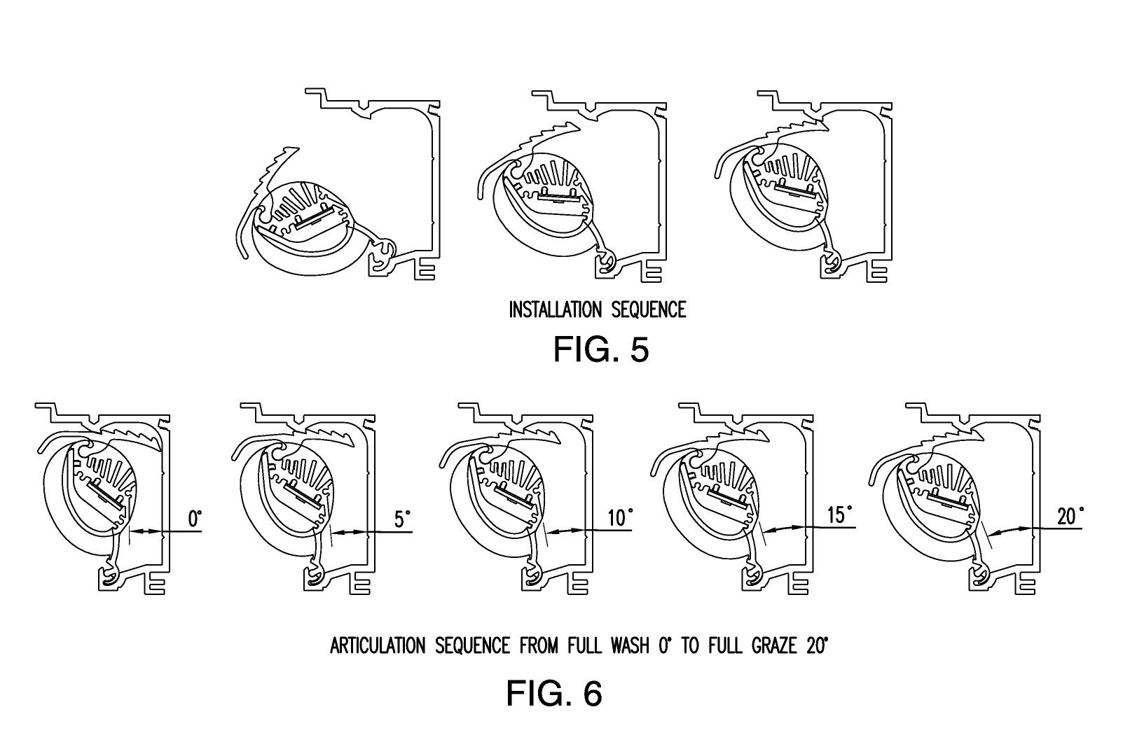

The fixture includes a linear light source such as an LED array 70 (FIG. 3). An exemplary light source is mounted on a carrier 74 (luminaire movable member) hinged for rotation about a horizontal axis (500) parallel to the wall (e.g., with a range of motion of an exemplary at least 15° or at least 30°). As is discussed further below, this hinging allows the light source orientation (pitch) to be adjusted to provide a desired washing effect of light along the wall. The exemplary carrier is also an aluminum extrusion which interfits with the main body to constrain relative movement to being the rotation about the axis 500. In the exemplary implementation, this interfitting means comprises a circular sectioned bead 76 (as an end protuberance on a short web 77) (FIG. 4) on the carrier extrusion interfitting with a complementary channel 78 in the main body extrusion 50. In the exemplary implementation, the carrier extrusion cross-section further includes a circumferentially extending arcuate finger 80 which seats in a complementary channel 82 in the main body extrusion 50. These may be essentially concentric about the axis 500 so that, with rotation of the carrier 74 about the axis 500, the finger 80 progressively inserts into and/or retracts from the channel 82. Cooperation of the finger 80 and the channel 82 helps retain the bead 76 engaged to the channel 78. This configuration also facilitates an installation sequence as shown in FIG. 5.

In the exemplary implementation, latches 90 provide for stepwise adjustment in the carrier orientation. The latches may be spring-loaded or free-floating. In an exemplary implementation, there are two latches longitudinally spaced apart along the length of the carrier extrusion 74. The exemplary latches comprise a user-actuatable lever portion 93 (FIG. 4) (e.g., finger-actuatable) on the opposite side of a fulcrum or pivot from a toothed 94 end portion 95 which cooperates with a complementary feature 96 of the main body so that the teeth provide the stepwise adjustability. Exemplary latches are cut from aluminum extrusions in short lengths (e.g., 1-10 cm). Exemplary latches are hinged for rotation about a hinge axis 502 via a bead 100 and channel 102 arrangement with the carrier. A portion of the bead 100 has a circular cross-section complementary to a cross-section of the channel 102. The exemplary channel is shaped to capture the bead. For example, the channel 102 may be dimensioned to accommodate the bead via an initial snap-in engagement. Alternatively, those dimensions are such that the bead may be inserted from the end of the channel and translated along the channel to be more robustly captured.

The exemplary LEDs 200 (FIG. 4) of the array 70 are mounted in a linear array on a board 202 and each put out a light pattern. One exemplary light pattern is a rotationally symmetric conical light pattern 204 with a cutoff at an angle θ₁ approximately 60° (thereby providing an approximately 120° (60° half angle) cone). In an alternative pattern, the light source is essentially Lambertian, emitting light into +/−90 degrees with a brightness falloff of approximately the cosine of the angle. Thus the intensity at 60 degrees is half that of 0 degrees. In an example of this alternative pattern, 75% of the total power is emitted within the central 120° marked in the drawings. Accordingly, that cone is still considered a particularly relevant reference and, preferably, the optic captures and redirects at least the light from that cone. By using an asymmetric optic 220 (lens), the symmetric light pattern emitted by the LEDs may be more efficiently distributed over the surface of the wall. An exemplary asymmetric optic is a transparent extrusion or injection molding (e.g., polycarbonate or acrylic) mounted to the carrier 74 and asymmetric across a longitudinal centerplane 522 of the source along which the axes 520 (of the LEDs 200 and their patterns 204) fall. In vertical cross-section, the lens 220 has a first face 222 generally toward the LEDs and a second face 224 generally away from the LEDs. In an exemplary implementation, along a region swept by the light cones, the first surface 222 is generally flat and normal to the plane 522. A corresponding region of the second surface 224 which passes light from the cone is convex along a first light-passing region 230 on one side of the plane 522 and a second light-passing region 232 on the opposite side. In the exemplary implementation, the region 230 is generally above and closer to the wall relative to the region 232. As is discussed further below, the exemplary optic generally angularly compresses light from the lower half of the distribution to increase intensity along the lower portion of the wall. It may also compress (but less significantly) light from the upper portion of the distribution or may spread (expand) the light from the upper portion of the distribution.

As mounting features, the exemplary lens is extruded with a first flange 240 beyond the region 232. The flange 240 is received in a channel 242 of the carrier 74. A second larger flange 246 extends beyond the region 220. In the exemplary implementation, holes may be drilled through this flange 246 to allow screwing of the flange to the carrier (e.g., via screws 248).

To mount the light source a desired distance from the wall surface, several different sizes of brackets 40 may be provided. Alternatively, or additionally, the brackets 40 and main bodies may have a variable relative mounting location.

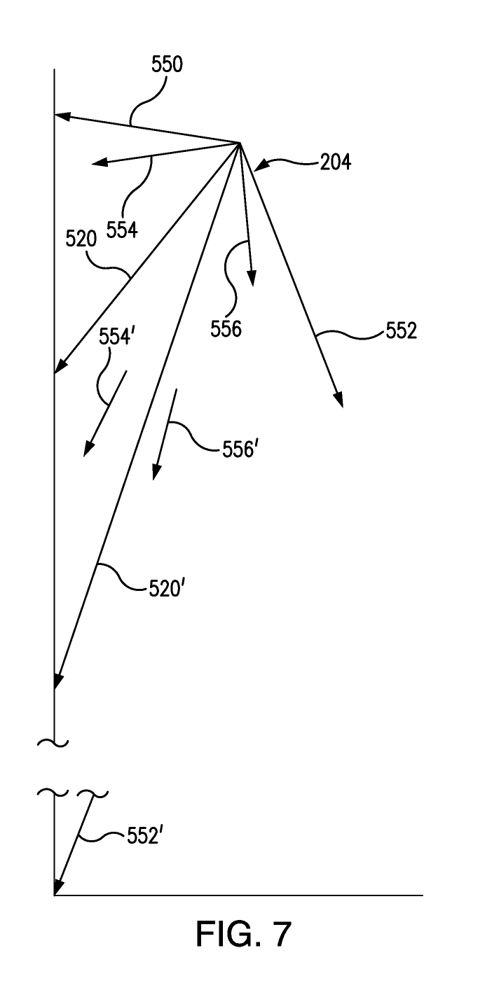

FIG. 7 shows an exemplary conical light pattern 204 with upper extreme shown as 550 and the lower extreme shown as 552. Additional lines are shown as 554 and 556 (equally opposite the centerline 520 partway to the respective extremes 550 and 552) for purposes of illustrating the effect of the optic. The exemplary optic bends the light emitted along the centerline 520 downward to 520′. There is a collimating effect wherein light on at least portions of both upper and lower sides are bent inward. In the exemplary implementation, there is more concentration on the lower half (e.g., between 520′ and 552′) than on the upper half (thus shifting 556′ closer to 520′ than 554′ is shifted). This produces an overall balance of the illumination of the wall. Light passing through the upper half tends to spread along a wider area on the upper portion of the wall and light passing through the lower half tends to correspondingly fall along the lower portion of the wall. Because the upper portion of the wall is closer to the fixture, the light exiting the optic may be proportionately less intense/concentrated along the upper portion of the optic and more intense/concentrated along the lower portion of the optic. Thus, 552 is shifted to 552′ which may fall along the wall or nearer to the wall than it would otherwise fall.

The asymmetric refraction of light that drives candle power further down the wall in an asymmetric distribution physically improves performance of the luminaire. It drives a significant portion of the total lumen output of the LED in an asymmetric fashion so it drives that light further down the wall thus creating a cleaner appearance and better light level. For example, the provision of an asymmetric distribution as emitted may lead to a more even distribution along the wall as light is shifted from portions of the wall nearer the LED to portions further down the wall.

Normally, the LED emits most of its light within a 120° cone, and the asymmetric optic captures a lot of that light and redirects it into a zone that falls along a lower portion of the wall. Also, light that would spill out (e.g., above the fixture and also onto the floor) is captured and redirected onto the visible portions of the wall. This is concentrating the light in the lower half of the cone and perhaps also spreading out the light in a portion of the upper half of the cone. It is also pulling light from the upper half and redirecting it down to the lower half moreso. There is still some light spill at the top but it may be much less. The optic is redirecting light down the wall so it is taking that intensity and driving it further down, redistributing the brightness on the wall to be more efficient, more uniform, and more pleasing aesthetically.

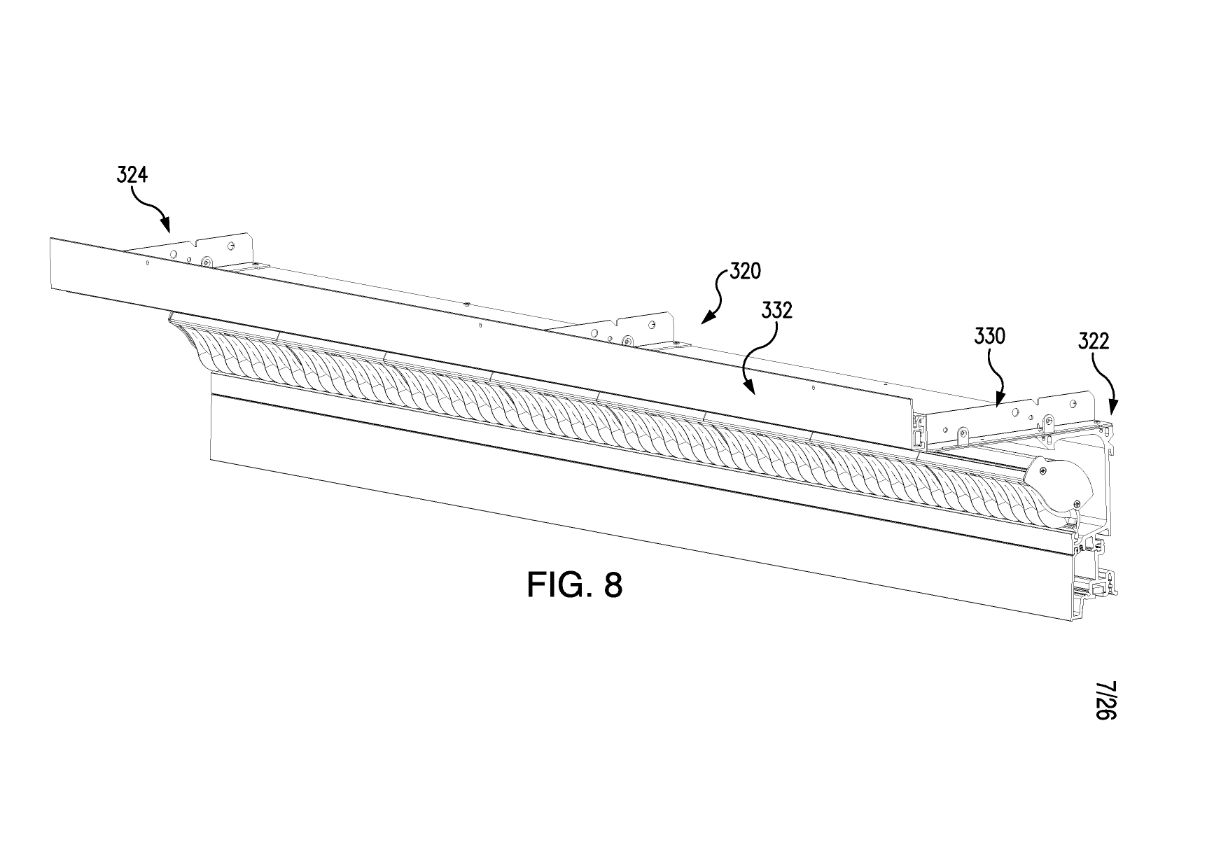

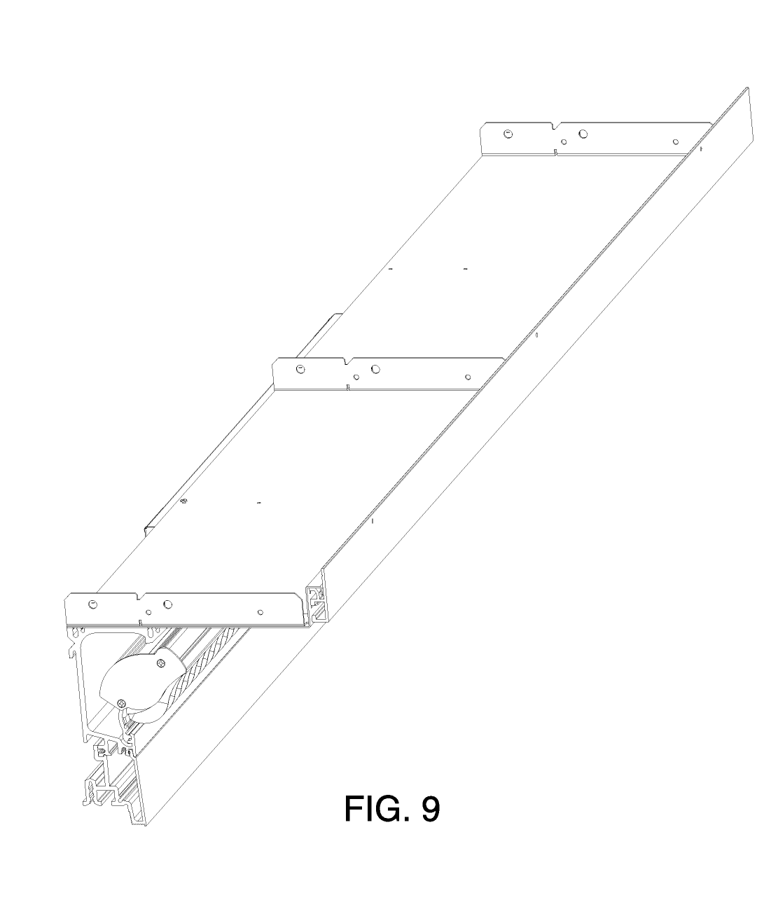

FIG. 8 shows a second fixture 320 extending from a first end 322 to a second end 324. Mounting brackets 330 replace brackets 40 and a mounting bracket 332 replaces bracket 42 but these may be similarly manufactured.

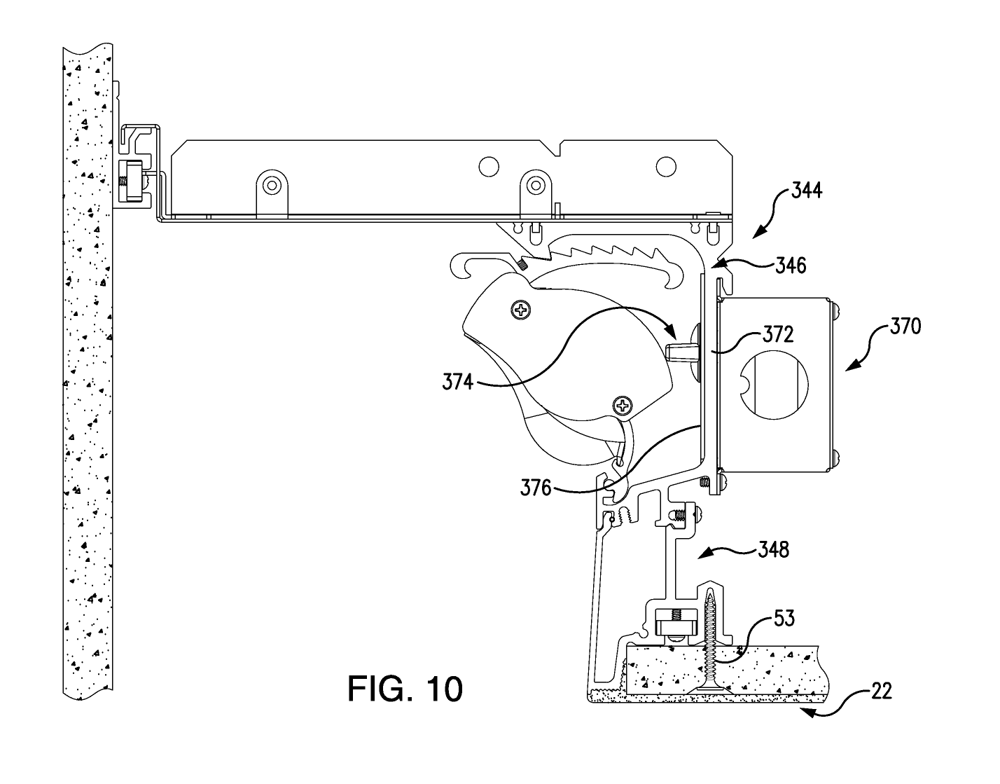

A fixture body 344 (FIG. 10) comprises a multi-piece assembly. The exemplary assembly comprises a main member 346 as a continuous aluminum extrusion holding a light source in a generally similar manner to the first fixture. A second body member serves to couple the main body to the aesthetic ceiling. In the FIG. 10 implementation, the second body member is a continuous cleat 348 (e.g., also an aluminum extrusion) to which ceiling boards may be mounted in a generally similar manner to the first fixture.

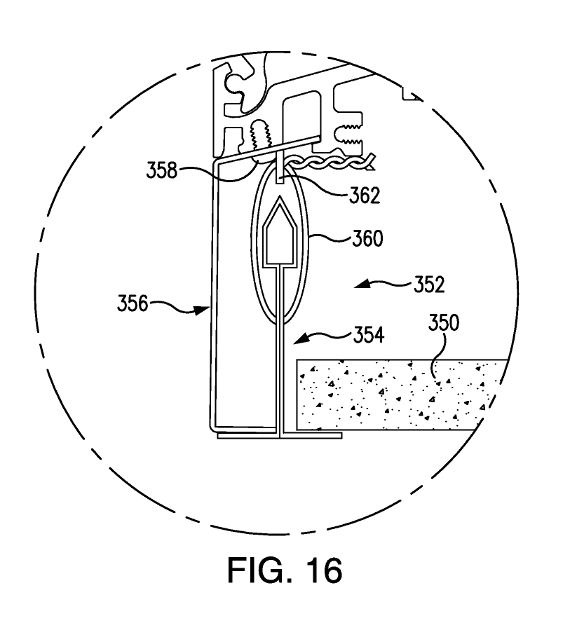

FIG. 16 shows an alternative to the body second member 348 for supporting perimeter portions of tiles 350 of a drop ceiling. Exemplary means 352 comprises a conventional inverted T-rail 354 with a head underside supporting the tile perimeter portion. The means 352 further comprises a flange 356 (e.g., cold rolled steel). The flange 356 may serve several functions. It may mount to the main body (e.g., via screws 358 into a downwardly-open channel in the lower front of the main body) and serve both to, in turn, mount the T-rail (e.g., via guy wires 360 through holes in bent tabs 362) and act as a cover hiding gaps between the T-rail and main body.

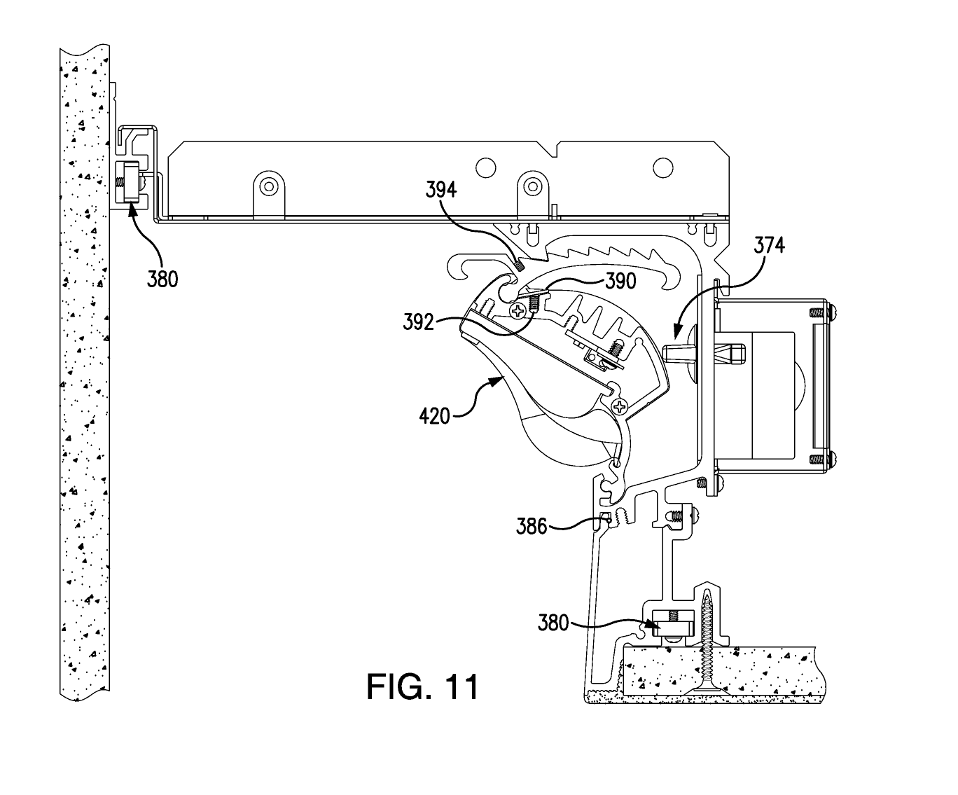

FIG. 11 shows the second fixture as including a revised lens/optic 420.

FIG. 10 shows the driver box 370 on the rear (facing away from the wall) surface of a main web. The exemplary driver box is secured via upper mounting ears (or a single flange) captured in a downward facing channel of the main body and lower mounting ears (or a single flange) screwed into a downwardly protruding lower portion of the main body web 372. FIG. 10 further shows a quarter turn release 374 mounting an access panel 376 (e.g., formed as an aluminum LED or stainless sheet) to the web 372 opposite the driver box. The light source may be rotated downward or even removed, exposing the release 374 to finger access.

FIG. 11 further shows linking bars 384 spanning gaps between adjacent extrusions. The exemplary bars 384 are accommodated in channels/pockets in the extrusions and are tightened down by screws applying compressive force between the tip of the screw and the opposite face of the linking bar across the channel.

FIG. 11 further shows a barrel pin 386 securing an upper portion of a forward web of the cleat 348 to a surface of a lower forward channel in the main member 346. A rear web of the cleat 348 is shown screwed to a complementary forward rear channel of the main member 346.

FIG. 11 further shows a spring 390 screwed to the carrier extrusion via a screw 392 and to the latch via a set screw 394 to cooperate with the latch to form a spring hinge and spring bias the latch into a latching condition.

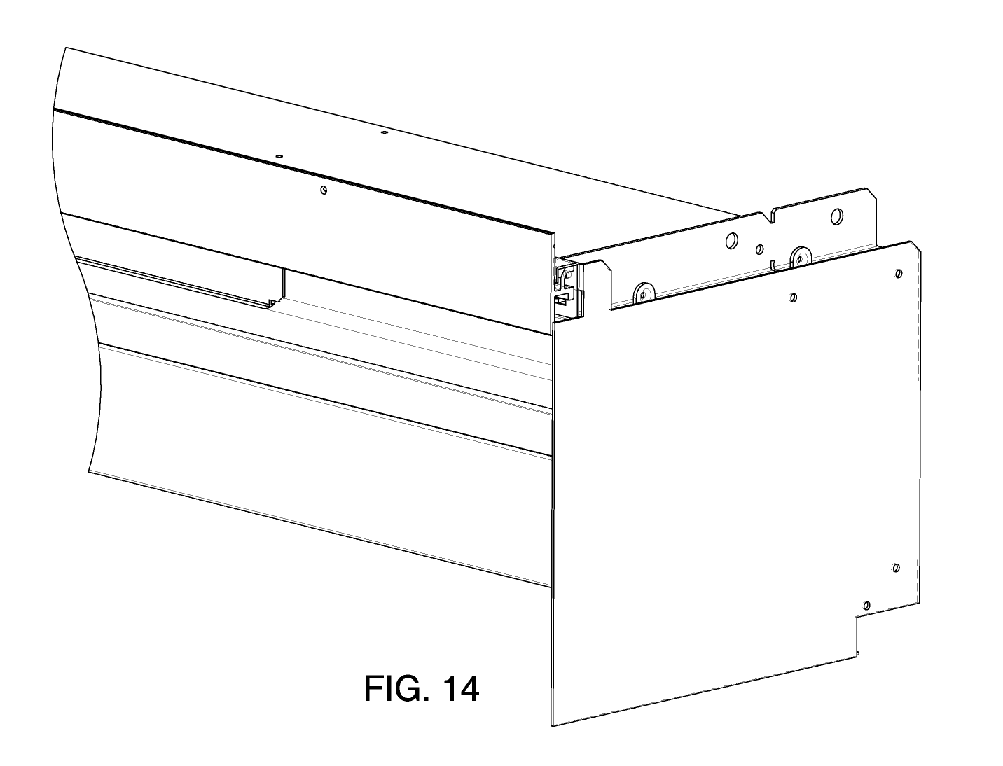

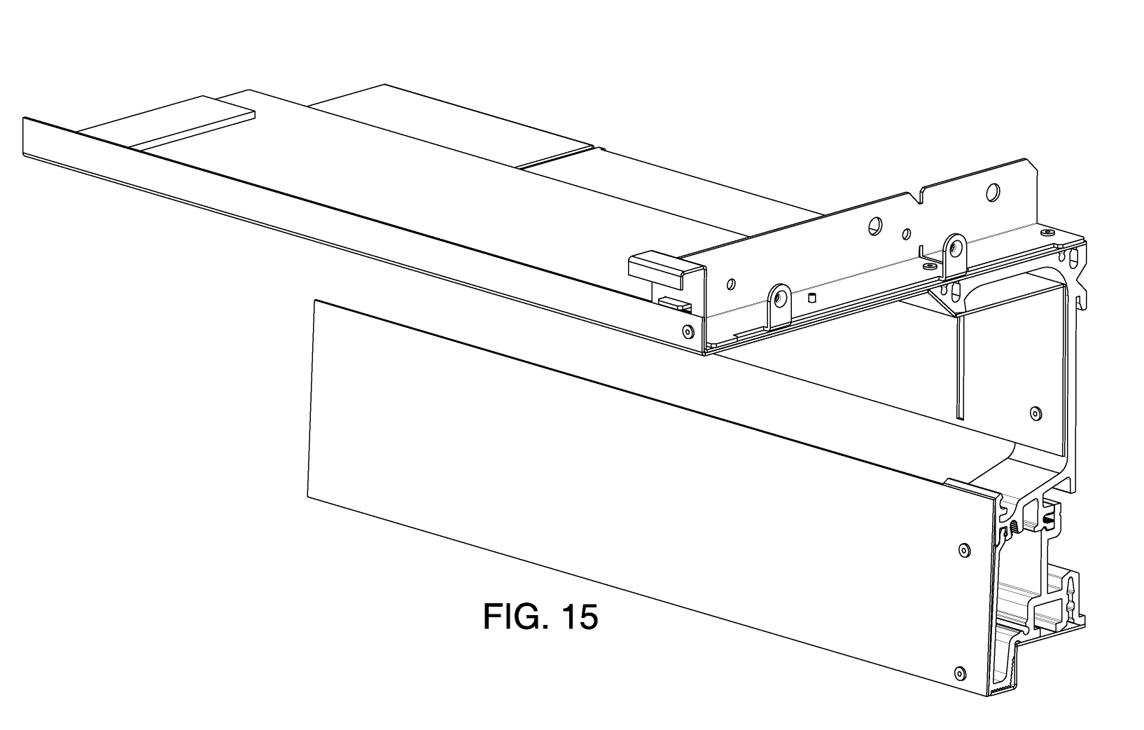

FIG. 14 shows a corner trim assembly for connecting two adjacent fixtures at an internal corner of a room. The assembly includes a mounting bracket combination to generally continue the mounting brackets along the wall. The assembly further includes support bracket portions generally similar to the brackets carrying the fixture body. The assembly further includes portions generally complementary to the fixture main body and any additional fixture body pieces so as to form the appearance of a continuous structure when mated to the adjacent fixtures. This may further include features for mounting to the adjacent fixture such as linking bars for joining adjacent body portions of the fixtures.

FIG. 4 shows an endplate assembly for use at the termination of a group of fixtures. FIG. 5 shows an intermediate spacer or fill-in kit which may be positioned anywhere along fixture array to create space. For example, it may be positioned between adjacent fixtures or between a fixture and the corner or the endplate. Multiple such spacers may be assembled end-to-end for additional length. The spacer has portions generally similar to the corner piece and fixture so as to provide a continuous visual appearance.

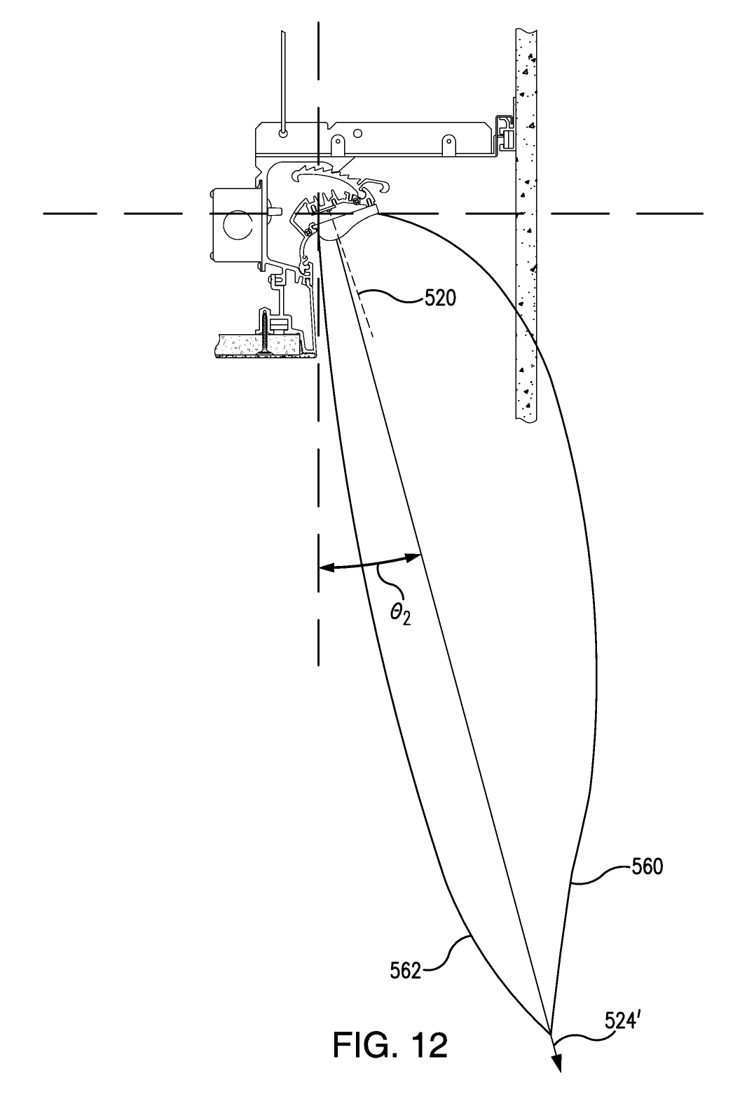

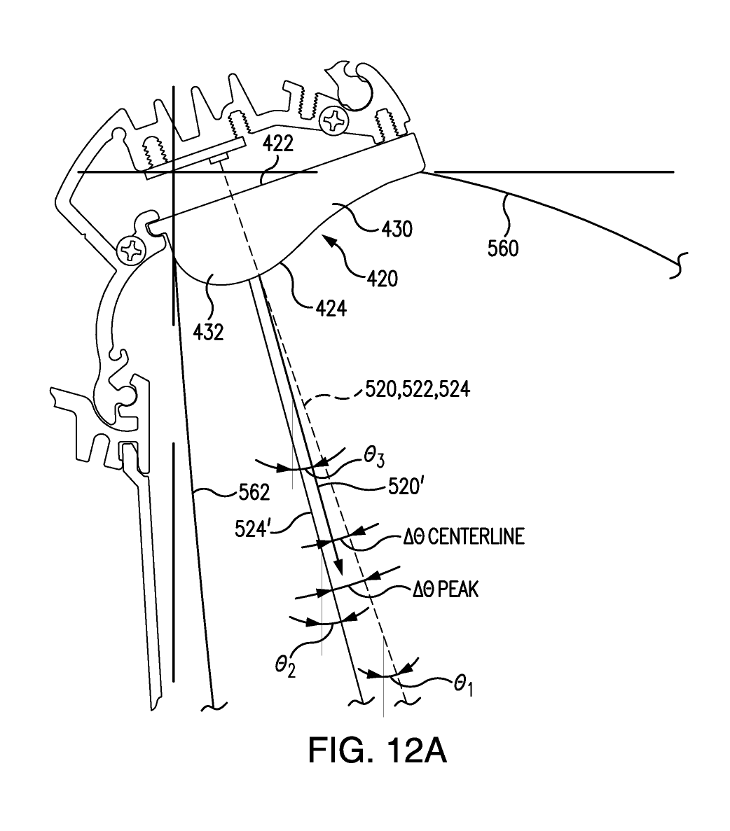

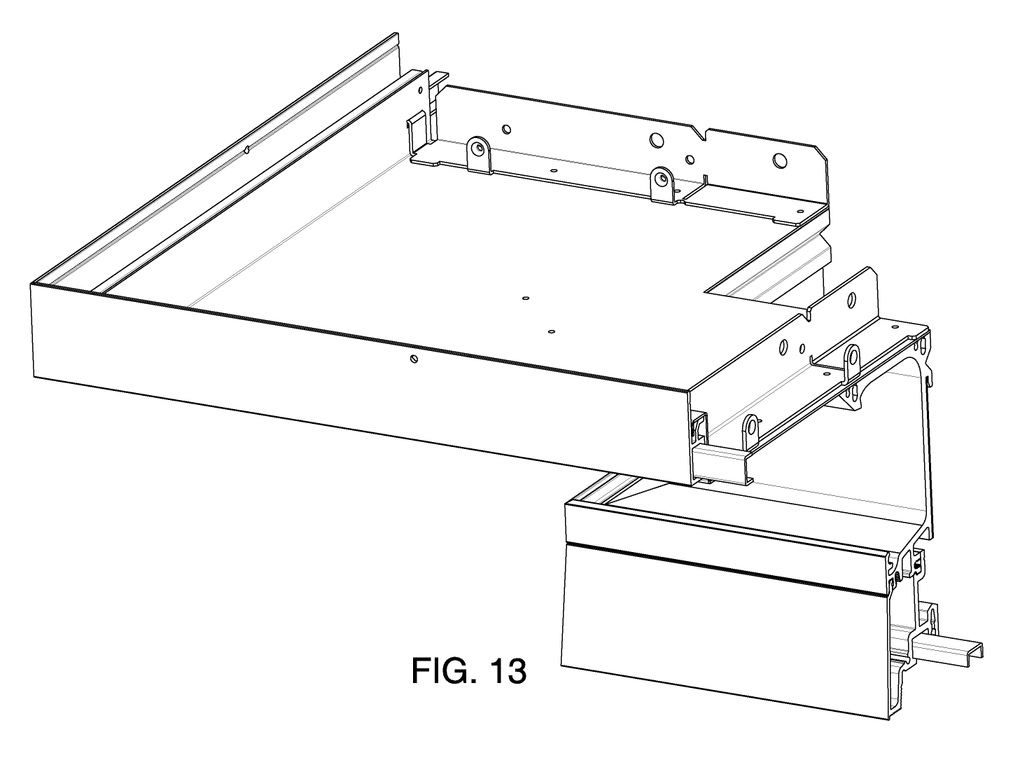

FIG. 12 (and FIG. 12A) is a view showing the optic 420 with endcap removed. The drawing further shows a plot of an exemplary measured light intensity. The axes/planes 520, 522 are oriented at an angle θ₁ about 20° off vertical. Peak light distribution (intensity) is shown by line/plane 524 (coincident with 520 and 522) as emitted at the LEDs and 524′ after refraction by the optic. Thus, the path 520′ of light emitted along the centerline 520 and peak distribution at 524′ are shifted by respective angles Δθ_{CENTERLINE} and Δθ_{PEAK} approximately 5° (e.g., 3-8° or 2-10°) downward (clockwise as viewed) to respective off-vertical angles θ₃ and θ₂ (e.g., 17+/θ3° in the example) relative to the axes 520, 524. Although 520′ and 524′ are shown as parallel, the asymmetry of refraction may cause them to slightly depart from each other. Lines 560 and 562 respectively represent the upper and lower boundaries of a 2-dimensional (2D) luminous intensity representation wherein the radial distance from the crosshairs/origin on the lines 560 and 562 indicates the luminous intensity (e.g., in candela). Thus the lines 560 and 562 converge at the peak intensity line/plane 524′. Thus, they appear to start off as cutoff lines associated with the approximately 120° conical patterns emitted by the LEDs.

FIG. 12 shows the lens/optic 420 having surfaces 422 and 424 and regions 430 and 432 generally corresponding to 220, 224, 230, and 232 respectively of the first optic. The region 432 is generally toward one side of the line/plane 520, 522 with 430 to the other. A peak distance between the surfaces 422 and 424 may be near the line 520, 522 (e.g., slightly downward therefrom as shown). Along the region 432, the thickness and surface 424 increasingly taper (away from the line/plane 520, 522) so as to be generally convex along a region swept by the associated half of the light cone. Along the region 430, however, rather than accelerating tapering away from the line/plane 520, 522, the tapering decelerates with the surface 424 transitioning from convex to concave. The thickness profile of the first optic similarly decelerates in taper and tapers more gradually than the opposite region without the concavity. This more gradual taper and the shallower angle of surface 424 relative to the surface 422 along the region 430 allows the region 430 to spread the light more than the region 432.

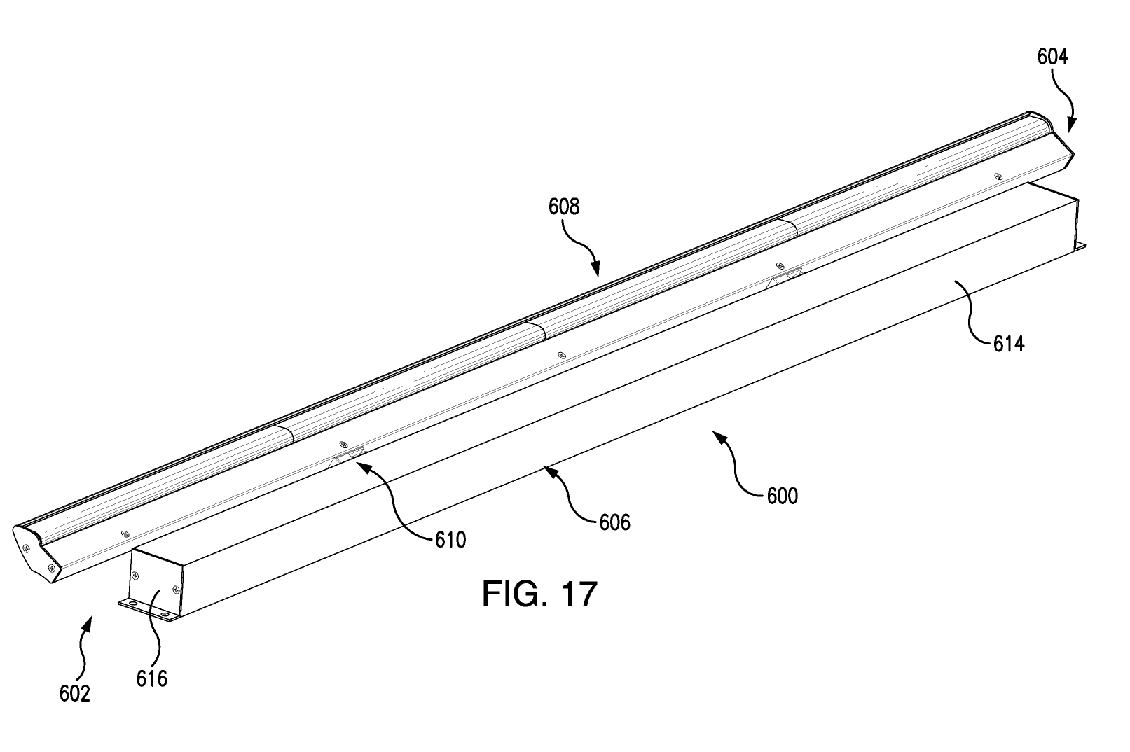

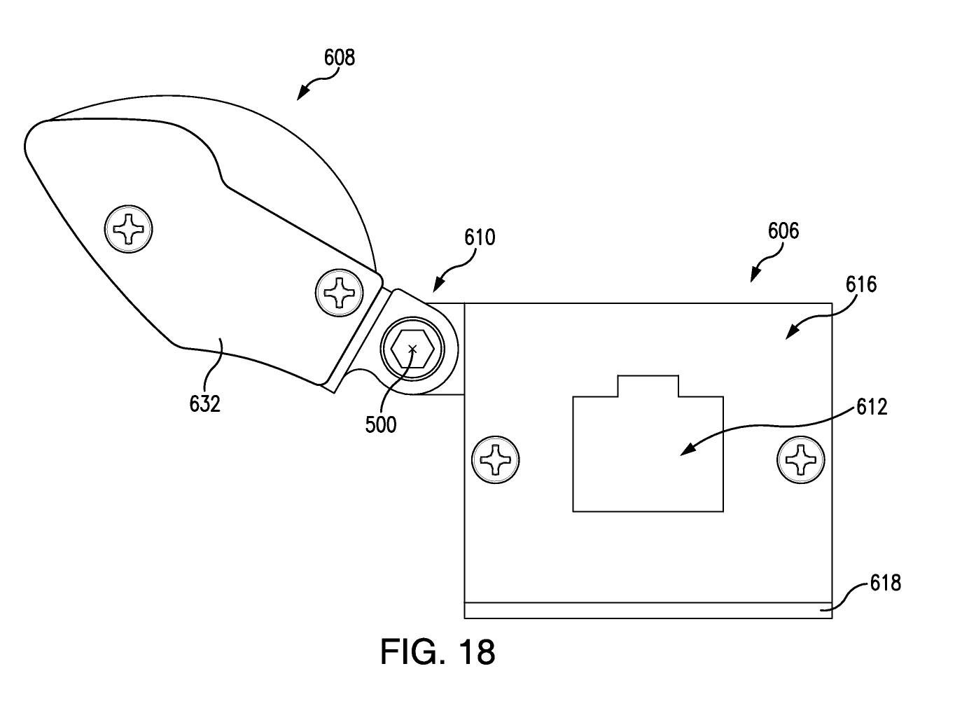

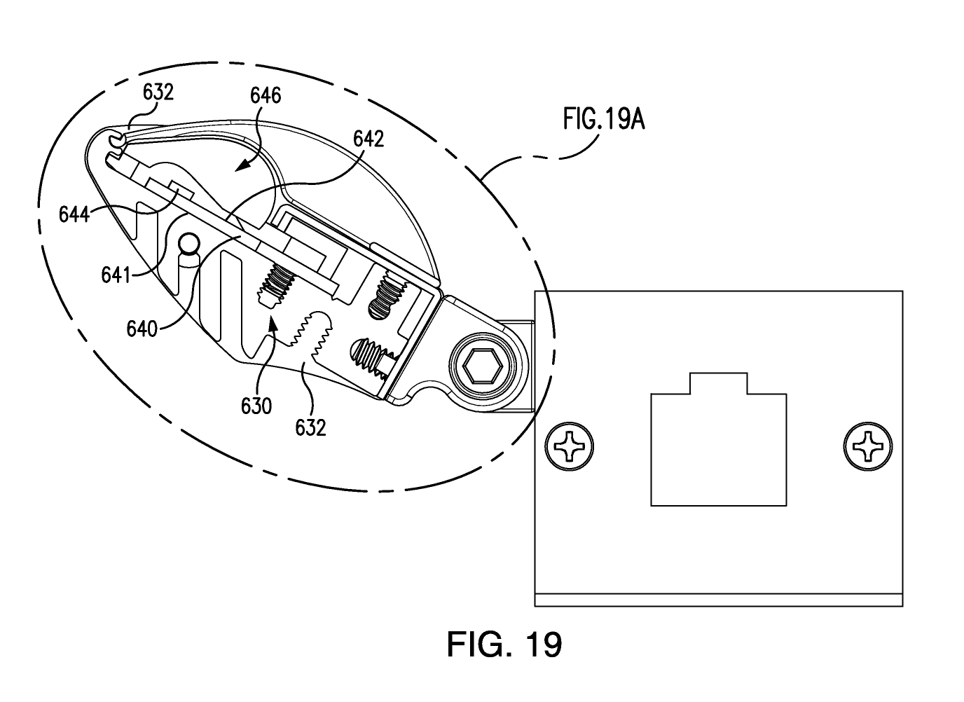

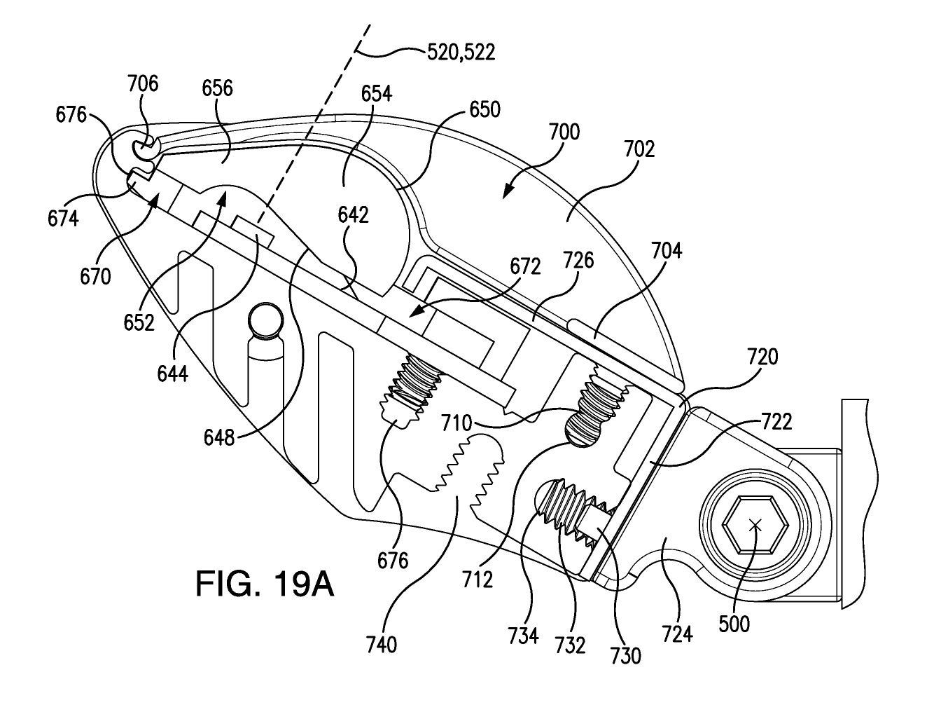

FIG. 17 is a view of a third fixture 600 which is relatively simplified structurally. The fixture extends from a first end 602 to a second end 604. The fixture comprises a base formed by a driver box 606. This fixture further comprises an adjustable pitch luminaire assembly 608 coupled to the driver box via hinges 610 for rotation about an axis 500 (FIG. 18). At each end of the driver box, a plug-and-play connector 612 may be mounted to allow interconnection of a series of fixtures. The box may be formed of steel or aluminum sheet metal or extruded aluminum. In the particular example, it is formed as a main extruded aluminum box section 614 with aluminum endplates 616 screwed at the ends of the main section 614 and having mounting feet 618 with mounting holes for screwing to an appropriate mounting surface. The luminaire assembly 608 may comprise a main body (e.g., extruded aluminum) 630 (FIG. 19) with endcaps 632 (FIG. 18).

There are several noteworthy aspects of the third fixture: (1) optic geometry; (2) features of the optic relating to mounting the optic and mounting the printed circuit board (PCB) carrying the LED's; and (3) the presence of multiple options for mounting the luminaire assembly to the hinges in different relative orientations.

FIG. 19 shows a printed circuit board (PCB) 640 having a first face 641 contacting the adjacent face of the main body 630 and an opposite second face 642 bearing the array of light emitting diodes (LEDs) 644.

As is shown in FIG. 19, the third fixture 600 includes an optic 646 having a first surface (face) 648 (FIG. 19A) facing generally toward the LEDs and receiving light from the LEDs and a second surface (face) 650 facing generally away and discharging light. The first surface has a recess 652 (recessed away from a plane parallel to the PCB). The exemplary recess is positioned/dimensioned to catch the entire light distribution. The presence of the first surface concavity helps bring the first surface close enough to the boundaries of the light distribution to capture and redirect essentially the entire distribution. Thus, at either side of the first surface concavity, the first surface meets or at least approaches the plane of the face of the LED. Thus, the exemplary optic captures the full 180° distribution. A narrower range might be to capture at least 160° of the 180° distribution then, in turn, pass at least the light from said 160° via the second surface. Along the exemplary recess, the first surface concavity varies in curvature magnitude oppositely to the convexity of the second surface. Namely, it is similar in shape function to the concavity of the second surface, but differs from it in scale and decentration.

FIG. 19A shows the centerplane 522 of the LED array, on one side of the plane, a proximal region 654 of the optic is analogous to the region 232 of FIG. 4 or 432 of FIG. 12A; whereas a region 656 is analogous to the regions 230 and 430. Progressively away from the plane 522 (e.g. distally of the hinge axis) the curvature of the concavity 652 tightens. Proximally of the plane 522, the curvature is less and may be essentially zero. The curvature of the surface 650 is generally opposite, tightening (decreasing magnitude of radius of curvature) proximally of the plane 522 and being essentially flat distally thereof. These two curvature variations combine to yet further increase the shift in light distribution discussed with respect to the prior embodiments. The resultant effect is that of a negatively powered concave-plano lens, gradually transforming across its surface into a positively powered plano-convex lens.

Additionally, the exemplary optic is mounted in a unique way which serves to simplify installation and improve registration with the LEDs. The optic is mounted at least partially to the printed circuit board and thereby registers with the printed circuit board. In addition to the main light-passing portion of the optic, the optic comprises a distal mounting feature 670 and a proximal mounting feature 672. As is discussed further below, the distal mounting feature 670 comprises a rail having a distal portion 674 captured in a channel 676 of the main body 630. The proximal mounting feature 672 comprises a series of tabs along the printed circuit board second surface 642 and screwed to the printed circuit board via associated screws received in a grooved channel 676.

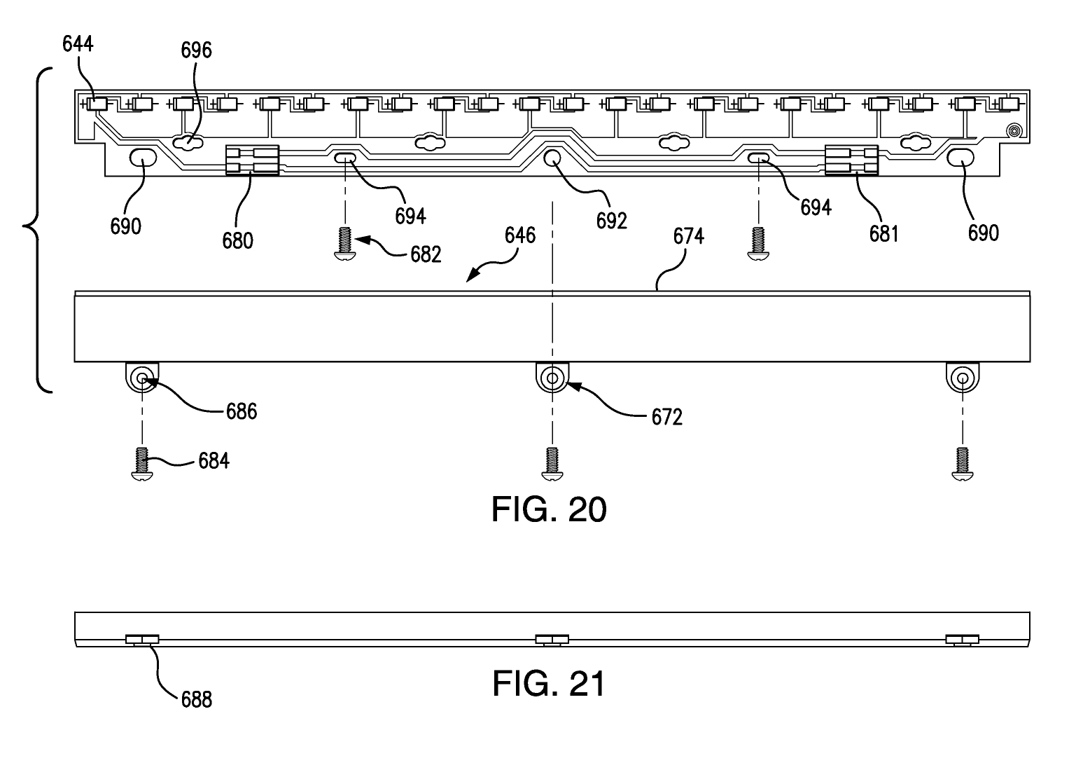

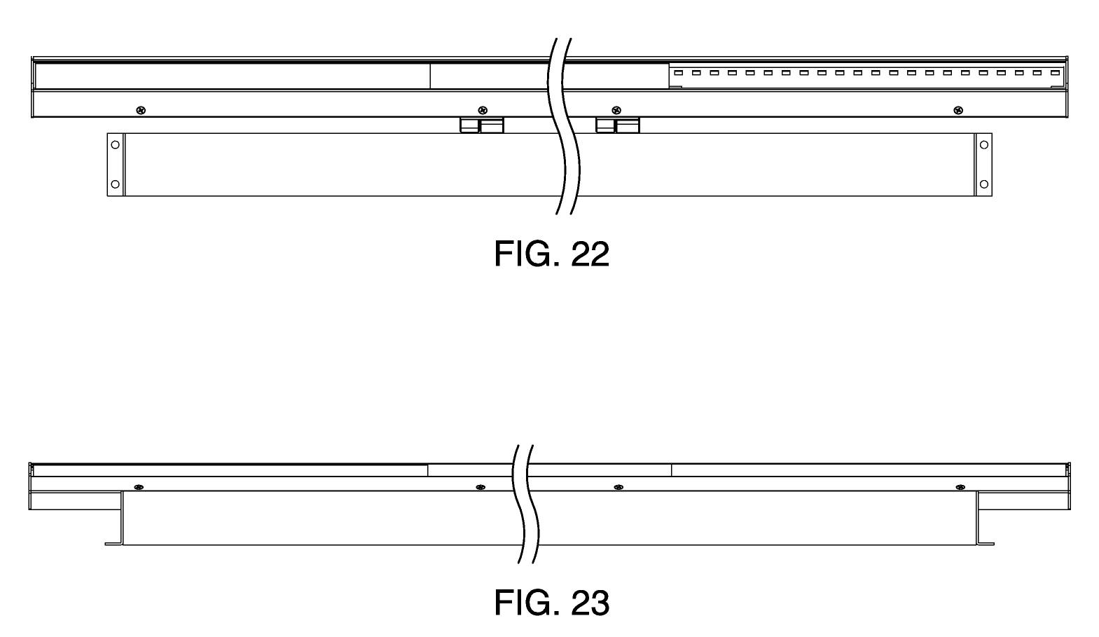

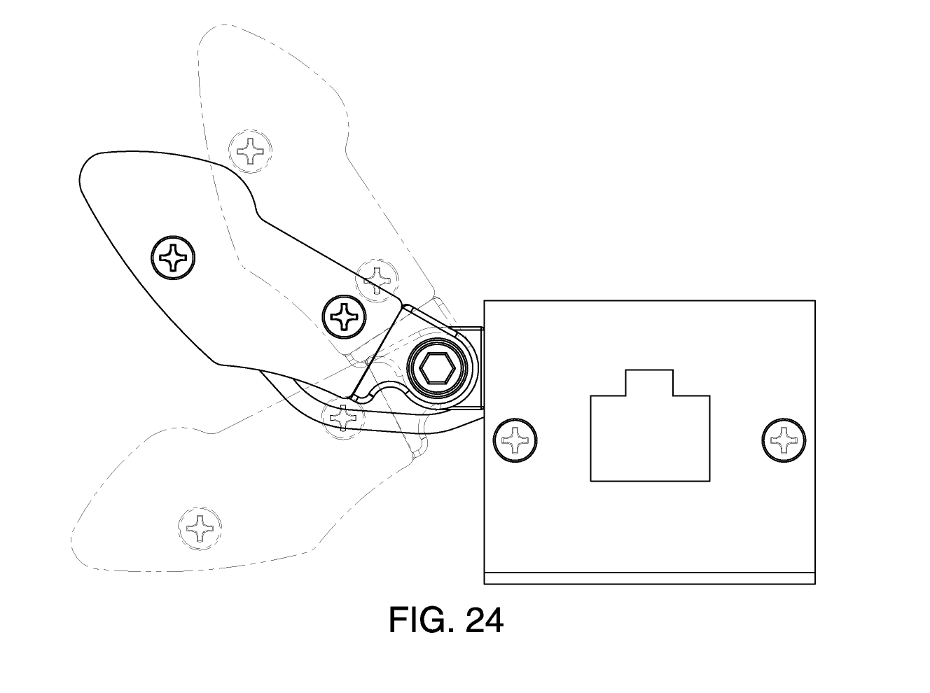

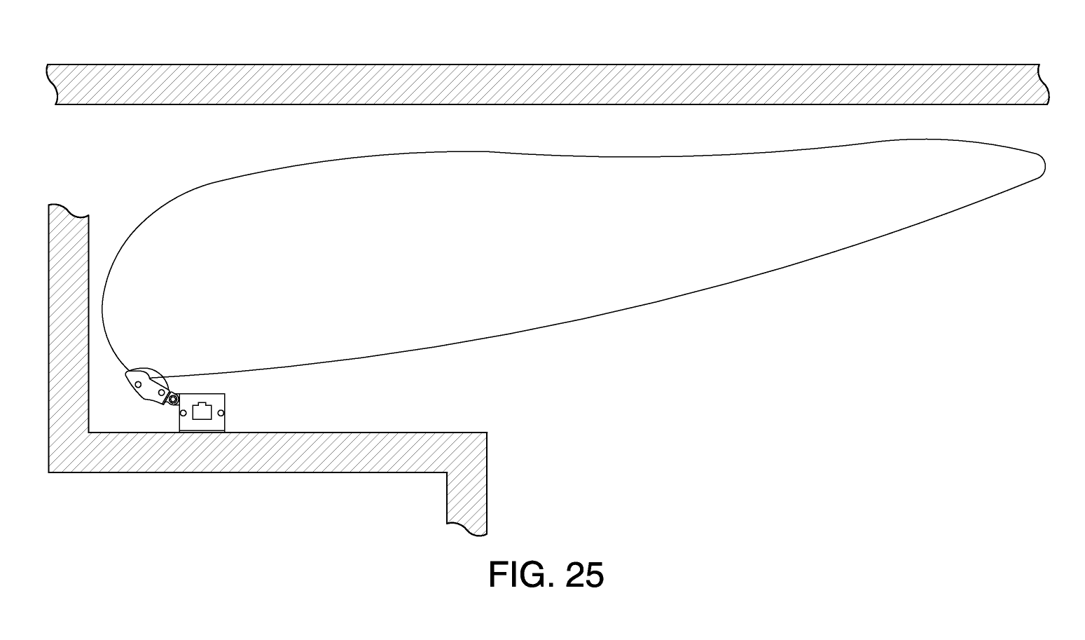

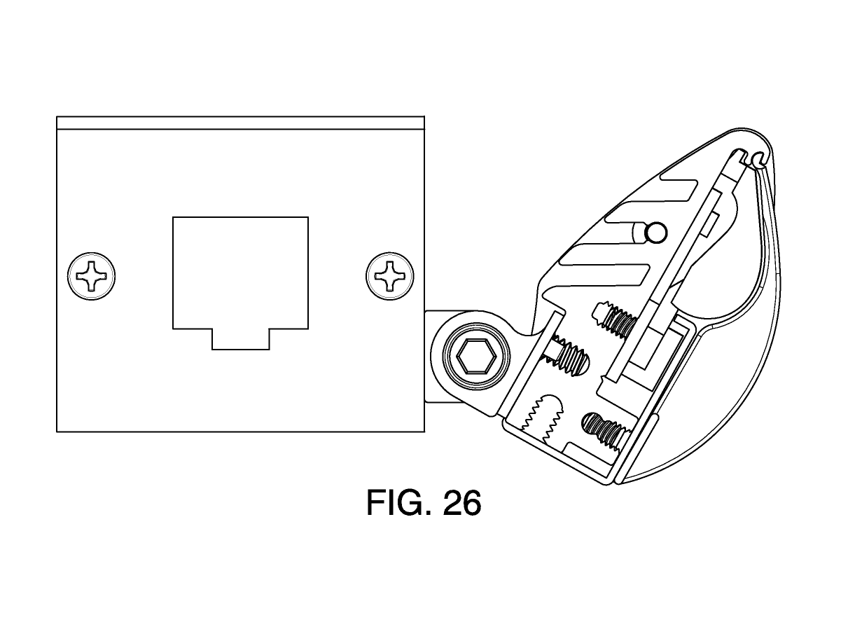

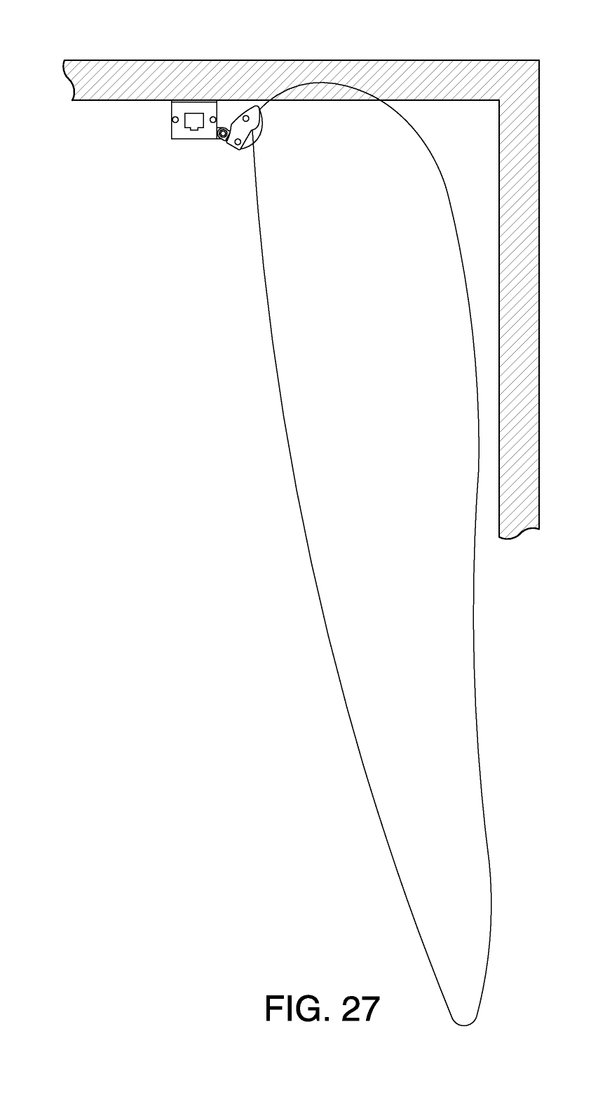

FIG. 20 is an exploded view of a sub-assembly of the printed circuit board with its LEDs and connectors 680, 681; screws 682 for securing the PCB to the main body 630; and a optic 646, and screws 684 for securing the optic to the PCB and main body 630. The exemplary optic includes three tabs 672 (e.g., a central tab and two lateral tabs near ends of the elongate molded optic (e.g., PMMA)). Each feature of the tabs includes a counterbored (although formed by molding) hole 686 for accommodating the head of the associated screw. A circular boss 688 protrudes from the underside of the tab surrounding the hole 686 and is received in a complementary hole 690 or 692 of the PCB as is discussed below.

FIG. 20 also shows the PCB with holes 694 for receiving the screws 682 and holes 696 for mounting to an alternate fixture (not shown).

FIG. 19A also shows a molded louver system 700. The louver system 700 may comprise a series of louver members, each member comprising a longitudinal array of louver fins 702 (e.g., spaced apart at a constant spacing over a length of the member). In one implementation, the louver members are molded (e.g., of polycarbonate) in lengths equivalent to the optic and PCB. In other implementations, they may be in longer lengths and cut down to correspond to the length of the assembly of optics and PCBs. At their proximal ends, the louver fins are joined by a mounting flange 704. At their distal ends, the louver fins are joined by a rail 706. The rail 706 is accommodated in an associated channel in the carrier extrusion. The flange 704 may be screwed down to the extrusion (e.g., via screws) 710 in a channel 712. The exemplary screws 710 are countersunk flathead screws and also serve to secure a cover 720 (e.g., painted sheet metal such as stainless steel or aluminum). The exemplary cover has a base portion 722 between an associated half 724 of the hinge and the carrier extrusion. A covering portion 726 extends forward and over portions of the circuit board including the connectors.

FIG. 19A also shows the attachment of the hinge half 724 to the carrier. Each exemplary hinge half 724 may be initially registered to the carrier via an integrally formed (e.g., cast) pin 730. The hinge half 724 includes a screw hole laterally spaced from the pin to receive a screw 732 which extends into a channel 734 in the carrier extrusion. FIG. 19A also shows an alternate channel 740 for mounting the carrier to the hinge in an alternate condition rotated relative to the FIG. 19A condition by an exemplary 90° (more broadly,80-100°).

In an exemplary sequence of assembly, the PCB is placed on the main body 630 and secured with screws 682. In a typical installation, the main body may be sufficiently long to accommodate multiple PCBs so-installed end-to-end. The screws 682 may initially be loosely installed allowing slight shifting of the PCBs to allow the boards to be positioned end-to-end. To this end, the exemplary holes 694 are elongate slots which may be an exemplary 2-3 times the diameter of the screw. The PCBs may be interconnected via connecting the connector 681 of one PCB to the connector 680 of the next using a cable. Thereafter, the screws 682 may be tightened down. Thereafter, the optics may be installed. In an exemplary implementation, there is one optic per PCB and thus the optics end up being arranged end-to-end. The optics are put into place by inserting their flanges 674 into the channel 676 and then rotating the tab end of the optic downward so that the bosses 688 are received in the associated holes 690 or 692. In this example, hole 692 is centrally positioned and the holes 690 are laterally positioned. The hole 692 is circular and dimensioned to tightly accommodate the associated boss to register the optic with the PCB. Due to considerations such as differential thermal expansion and manufacturing variances, the slots 690 are at least somewhat elongate (e.g. approximately twice the diameter of the boss) and slightly wider to allow the boss seating. With the optic seated, screws 684 may be installed and tightened down. The endplates may be attached. In the exemplary implementation, the cover may be secured in place and hinges attached (to attach the carrier to the driver box). A terminal one of the connectors of the series of PCBs may be connected to a cable for subsequent connection to the associated driver.

One or more embodiments of the present invention have been described. Nevertheless, it will be understood that various modifications may be made without departing from the spirit and scope of the invention. For example, the environment into which the fixture to be mounted may influence body configuration. Accordingly, other embodiments are within the scope of the following claims.

What is claimed is:

1. A light fixture comprising:
a body (34;344;606);
a plurality of light emitting diodes (LEDs) (200;644);
a carrier (74;630) supporting the light emitting diodes and pivotally mounted to the body; and
an asymmetric lens (220;420;646) mounted to the carrier.

2. The fixture of claim 1 wherein:
the body is elongate in a first lateral direction; and
the pivotal mounting is parallel to said first lateral direction.

3. The fixture of claim 1 further comprising:
a latch (90) securing the pivotal mounting of the carrier.

4. The fixture of claim 3 wherein:
the latch stepwise secures the pivotal mounting of the carrier.

5. The fixture of claim 1 wherein:
the lens is an asymmetrical extrusion or injection molding.

6. The fixture of claim 5 wherein:
the lens asymmetry asymmetrically collimates the output of the LEDs.

7. The fixture of claim 1 wherein:
the pivotal mounting is provided by at least one hinge; and
the carrier comprises two alternative mounting features so as to allow mounting the carrier relative to the hinge in two alternative orientations.

8. The fixture of claim 1 wherein:
the plurality of light emitting diodes (644) are mounted to a circuit board; and
the lens is secured to an extruded main body of the carrier to sandwich the circuit board between the lens and the main body.

9. The fixture of claim 8 wherein:
the lens straddles the light emitting diodes with a plurality of tabs attached with screws through the tabs and the circuit board and an opposite lip captured by a channel in the carrier main body.

10. The fixture of claim 1 wherein:
the plurality of light emitting diodes (200;644) are in a linear array to emit a pattern of light having a centerplane (522); and
the asymmetry of the lens distributes light from one side of the centerplane differently than light from the other side of the centerplane.

11. The fixture of claim 10 wherein:
the asymmetry of the lens compresses the distribution light from said one side of the centerplane.

12. The fixture of claim 11 wherein:
the asymmetry of the lens compresses the distribution light from said other side of the centerplane.

13. The fixture of claim 11 wherein:
the asymmetry of the lens spreads the distribution light from said other side of the centerplane.

14. The fixture of claim 10 wherein:
the asymmetry of the lens redirects light emitted along the centerplane.

15. The fixture of claim 1 wherein:
the lens has a convex outer profile and a concave inner profile.

16. The fixture of claim 1 mounted to a wall and ceiling wherein:
the body is supported by the wall;
a peripheral portion of the ceiling is mounted to the body; and
the plurality of light emitting diodes are recessed above a surface of the ceiling and positioned to direct light along the wall.

17. The fixture of claim 1 wherein:
the body and the carrier are each formed as at least one aluminum or an aluminum alloy extrusion.

18. The fixture of claim 17 wherein:
the pivotal mounting of the carrier to the body is provided by cooperation of a bead (76) on one of the body and the carrier with a channel (78) on the other of the body and the carrier.

19. A method for installing the fixture of claim 1 comprising:
mounting the body to a wall;
mounting a peripheral portion of a ceiling to the body; and
adjusting the carrier so that the plurality of light emitting diodes are oriented and positioned to direct light along the wall.

20. The method of claim 19 wherein:
a plurality of said fixtures are assembled end-to-end.

21. The method of claim 19 wherein:
the mounting of the body is via a plurality of brackets; and
the mounting of the peripheral portion of the ceiling comprises screwing directly to the body.

22. An asymmetric lens (220;420;646) having:
a first surface (222;422;648) for receiving incident light;
a second surface (224;424;650) for discharging the received light; and
an asymmetry providing means for asymmetrically shifting a light distribution of the received light.

23. The lens of claim 22 wherein:
the first surface has a concave asymmetric portion which is a scaled and shifted version of a convex asymmetric portion of the second surface.

24. The lens of claim 22 wherein:
the asymmetry provides the effect of a negatively powered concave-plano lens, gradually transforming across its surface into a positively powered plano-convex lens.
